(19) United States
(12) Patent Application Publication
(10) Pub. No.: US 2024/0190898 A1
(43) Pub. Date: Jun. 13, 2024

(54) SYNTHESIS METHOD OF ZINC METAL ORGANIC FRAMEWORK MATERIALS

(71) Applicant: Svante Inc., Burnaby (CA)

(72) Inventors: Omid GHAFFARI-NIK, Burnaby (CA); Yan GAO, Burnaby (CA); Joel CIZERON, Burnaby (CA); Nima MASOUMIFARD, Burnaby (CA); Azadeh MOLAIE, Burnaby (CA); Robert TOY, Burnaby (CA); Pierre HOVINGTON, Burnaby (CA)

(21) Appl. No.: 18/276,963

(22) PCT Filed: Feb. 22, 2022
(86) PCT No.: PCT/IB2022/051562

§ 371 Date: Aug. 11, 2023

Related U.S. Application Data
(60) Provisional application No. 63/152,198, filed on Feb. 22, 2021.

(51) Int. Cl. C07F 3/06

(52) U.S. Cl. CPC C07F 3/06

(57) ABSTRACT

Embodiments of the invention generally relate to a method of preparing a metal organic framework (MOF), and specifically a zinc MOF having the formula Zn₂Ht₂Ox. The method generally comprises contacting at least one cycloazocarbyl compound, such as a N-heterocyclic compound with an oxalate (or a dicarboxylic acid or a dithio compound) with a zinc cation in a liquid suspension at a temperature equal to or less than 100° C. and a pressure of about 1 atmosphere.

### FIELD

The present invention relates generally to methods of synthesis of metal organic frameworks. More particularly, the present invention relates to methods of synthesis of zinc containing metal organic frameworks.

### BACKGROUND

Metal organic frameworks (herein referred as “MOFs”) and porous coordination polymers (herein referred as “PCPs”) are a class of network solids composed of organic spacers linking metal ions or metal ion clusters. These materials are useful because of their high surface area and properties of the complexed metal including ordered (crystalline) structures permeated by pores. The regularity of these materials makes them amenable to structural characterization by X-ray diffraction techniques. The properties are of particular interest for rapid adsorption of gases. This class of material is proposed for adsorbing and separating gasses, for example, carbon dioxide (herein referred as “CO₂”) from industrial effluents, for example, a replacement for amine scrubbing of CO₂.

Water stability has been shown to be a weakness for many MOFs as even low amounts of atmospheric moisture can compromise order and porosity. Identifying materials combining high capacity for CO₂ capture with high stability in presence of moisture or steam is a challenge. Industrial flue gas contain both molecules and removing moisture from flue gas prior to CO₂ capture would have very significant energy cost penalty as well as undesirably increase capital cost of a capture system.

U.S. Pat. No. 9,782,745, issued Oct. 10, 2017 titled “METAL ORGANIC FRAMEWORK, PRODUCTION AND USE THEREOF”, discloses certain Zn MOFs which exhibit high CO₂ adsorption capacity with high selectivity for adsorption of CO₂ compared to nitrogen and moreover exhibit good thermal stability and good stability to water. MOF therein could be subjected to a plurality of adsorption and desorption cycles with complete reversibility.

PCT International Publication WO 2019/204934 titled “SYNTHESIS OF ZINC MOF MATERIALS”, teaches an improvement on the synthesis technique for preparing the Zn MOF disclosed in U.S. Pat. No. 9,782,745.

Both U.S. Pat. No. 9,782,745 and PCT Publication WO 2019/204934 disclose a metal-organic framework (MOF) having pores and wherein the framework includes zinc ions, oxalate, and a cycloazocarbyl compound. The cycloazocarbyl compound of the MOF therein is described as at least bidentate, having 2, 3 or 4 nitrogen atoms, typically as part of a 5-membered ring. Examples of cycloazocarbyl compounds therein are imidazolates, triazolates and tetrazolates, and more particularly 1,2,4-triazolate, 1H-1,2,4-triazolate-1-carboxamidine, 3-amino-1,2,4-triazolate, imidazolate, 4-fluoroimidazolate, 2-methyl-imidazolate and 1,2,3,4-tetrazolate. Of particular interest therein is a Zn(II) material designated CALF-20, having the chemical formula Zn₂TZ₂Ox (where, Tz=1,2,4-triazolate, and Ox=oxalate).

U.S. Pat. No. 9,782,745 exemplifies the synthesis of a particular example within this family of Zn MOF identified as CALF-20 which is performed as a batch process solvothermally in a sealed autoclave at pressure above ambient pressure. In this procedure, Zn(II) oxalate and a stoichiometric excess of 1,2,4-triazole with respect to both Zn and oxalate was added to water and methanol in a polytetrafluoroethylene (PTFE)-lined autoclave. The mixture was subsequently heated in the sealed autoclave to 180 ºC for 48 hours (i.e., at high pressure) and washed with water. The space-time yield for this process is relatively low, of the order of about 40 kg/m3/h, making the cost of synthesis a significant limiting factor for CALF-20 and related MOFs. The reaction could also be carried out in pure methanol or ethanol. Subsequently, it has been found that in some cases, CALF-20 prepared by the autoclave method contains zinc oxide impurity as assessed by PXRD (powder X-ray diffraction), that is fully removed by an annealing process comprising two steps of heating to 200° C. for 24 hours for each step, with a cooling and washing step in between. This purification step, however, adds additional time and cost to the synthesis of CALF-20.

WO 2019/204934 discloses an improvement on the synthesis technique for preparing CALF-20 at reduce temperature and pressure. This method relies on forming a compound of cycloazocarbyl and oxalate or oxalate mixed with an additional chelating ligand prior to adding a zinc salt into the reaction media. The disclosure also exemplify the use of low alcohol plus water mixture as the solvent only.

Barriers of commercial adaptation of Zn MOFs such as CALF-20 in gas separation applications, include complex synthesis processes and high synthesis costs using conventional synthesis processes. Specific shortcomings of synthesis process known in the art include, for example, low space-time yields, use of hazardous solvents, and/or formation of hard to separate impurities. The use of solvents during synthesis offers challenges including requiring appropriate equipment and processes for safe processing and handling. Novel PCP and MOF synthesis techniques which overcome one or more of these barriers are desired.

### SUMMARY

In a broad aspect of the present invention, a method for preparing a Zn MOF of composition of formula Zn₂Ht₂Ox where:
Ht is a first N-heterocyclic compound selected from 1,2,4-triazolate, or a combination of 1,2,4-triazolate and at least a second N-heterocyclic compound, where the first N-heterocyclic compound is different from the second N-heterocyclic compound;
Ox is an oxalate a dianion form of a diacid oxalic acid or adicarboxylic acid or a dithio compound; and
Zn is a zinc cation,
   comprises contacting the first N-heterocyclic compound and optionally the second N-heterocyclic compound, the oxalate or the dicarboxylic acid or the dithio compound, in a liquid suspension where the liquid suspension is at temperature equal to or less than 100° C. and at a pressure within 0.9 to 1.1 atmospheres, and a solvent comprising water, and forming crystals of the Zn MOF.

In another broad aspect of the present invention, a method for preparing a Zn MOF of composition of formula Zn₂Ht₂Ox, where:
Ht is a first N-heterocyclic compound selected from 1,2,4-triazolate, or a combination of 1,2,4-triazolate and a second N-heterocyclic compound, wherein the first N-heterocyclic compound is different from the second N-heterocyclic compound;
Ox is an oxalate a dianion form of a diacid oxalic acid or a dicarboxylic acid or a dithio compound; and
Zn is a zinc cation,

comprises contacting the first N-heterocyclic compound, optionally the second N-heterocyclic compound, the oxalate or the dicarboxylic acid or the dithio compound, in a liquid suspension where the liquid suspension is at a temperature equal to or less than 100° C. and at a pressure within 0.9 to 1.1 atmospheres, and a solvent consisting exclusively of water, and forming crystals of the Zn MOF.

In a further embodiment of the present invention, a method for preparing a zinc containing MOF or Zn MOF of formula: Zn₂Ht₂Ox, where:
Ht is a 1,2,4-triazolate;
Ox is an oxalate a dianion form of the diacid oxalic acid; and
Zn is a zinc cation,
   comprises contacting the 1,2,4 triazole, an oxalate salt and a zinc salt or a zinc oxide, in a liquid suspension where the liquid suspension is at a temperature equal to or less than 100° C. and at a pressure within a range of 0.9 to 1.1 atmospheres, with a solvent comprising water.

In yet a further embodiment of the present invention, a method for preparing a zinc containing MOF or Zn MOF of formula: Zn₂Ht₂Ox, where:
Ht is a 1,2,4-triazolate;
Ox is an oxalate a dianion form of the diacid oxalic acid; and
Zn is a zinc cation,
   comprises contacting the 1,2,4 triazole, an oxalate salt and a zinc salt or a zinc oxide in a liquid suspension where the liquid suspension is at a temperature equal to or less than 100° C. and at a pressure within a range of 0.9 to 1.1 atmospheres, with a solvent consisting exclusively of water.

### BRIEF DESCRIPTION OF THE DRAWINGS

FIG. 1 compares the powder X-ray diffraction (PXRD) of a CALF-20 Zn MOF made as described in WO 2019/204934 to the Zn MOFs made as described in Example 3 and Example 4. The diffraction peaks in X-ray diffraction lines 1, 2, and 3 are substantially the same which indicates the Zn MOFs prepared by these methods have substantially the same structure.

### DETAILED DESCRIPTION

### Definitions:

The term alkyl refers to a monovalent saturated hydrocarbon radical which may contain from 1 to 12 carbon atoms (a C₁-C₁₂ alkyl). The alkyl group may be straight-chain or branched. The alkyl group is optionally substituted. In specific embodiments, alkyl is a C₁-C₃ alkyl.

The term aminoalkyl refers to an —NHR monovalent radical, where R is an alkyl group as described above.

The term dialkylamino refers to an —N(R)₂ monovalent radical, where each R is an alkyl group as described above. In specific embodiments, R is a C₁-C₃ alkyl. The term amino refer to an —NH₂ group.

The term cycloalkyl refers to an alkyl radical having a 3-8 member carbon ring. The cycloalkyl group is optionally substituted.

The term alkenyl refers to a monovalent hydrocarbon radical containing one or more double bonds, which may contain from 2 to 12 carbon atoms (a C₁-C₁₂ alkyl). The alkenyl group may be straight-chain or branched. The alkenyl group is optionally substituted.

The term cycloalkenyl refers to an alkenyl radical having a 3-8 member carbon ring. The one or more double bonds are in the carbon ring. The cycloalkyl group is optionally substituted. In an embodiment, a cycloalkenyl group contains one double bond.

The term alkynyl refers to a monovalent hydrocarbon radical containing one or more triple bonds, which may contain from 2 to 12 carbon atoms (a C₂-C₁₂ alkynyl).

The term N-heterocyclic refers to a chemical species that contains a 5-8 member ring wherein the ring contains at least one nitrogen. The other ring members may be carbon, one or more additional nitrogen or one or more oxygen or sulfurs. The ring may contain one or more double bonds or be aromatic.

The term lower alcohol refers to alkyl alcohols having 1-4 carbon atoms and includes all isomers thereof. The term includes mixtures of lower alcohols. In a specific embodiment, the lower alcohol is ethanol.

Aqueous alcohol refers to mixtures containing water and alcohol, preferably lower alcohol. Aqueous alcohol may contain a mixture of two or more alcohols, preferably a mixture of two or more lower alcohols.

Stoichiometric excess refers to the relative amount of reagent or compound in excess of the stoichiometric amount as defined in the formula Zn₂Ht₂Ox, where the number represent the relative molar content of compounds in the product.

Solvent refers to liquid media used to suspend or dissolve reagents or compounds.

Room temperature is a temperature in a range of about 15° C. to about 30° C.

The term atmosphere refers to a surrounding environment in which a person and/or a process operates. A standard pressure of an atmosphere is 101 kilopascals at sea level.

The term zinc compound refers to two or more zinc containing materials as a liquid or solid.

WO 2019/204934 discloses a synthesis method of producing a Zn MOF employing a specific order of addition along with a solvent other than water (non-water based solvents).

The present methods of synthesis produces Zn MOFs including, for example, CALF-20, with a porous crystalline structure having desirable properties including selective adsorption of one or more gas species as well as good thermal and steam exposure stability. The present methods reduces the formation of hard to separate impurities while providing more economical conditions of synthesis and solvents, as well as eliminating the use of pressure vessels during synthesis. The present methods may also eliminate the use of light alcohol as a synthesis solvent and/or eliminate a step of addition of a reagent, relative to methods disclosed in WO 2019/204934. Furthermore, the present methods includes changing the order of reagent addition from disclosed in WO 2019/204934 which greatly shortens the reaction times for formation of the desired Zn MOF structure while providing a high yield and a high purity.

The present methods greatly impacts the type of equipment used enabling adaptation of the present synthesis methods with relative ease in existing chemical manufacturing plants, as well as eliminating or reducing the amount of waste containing hazardous chemicals during synthesis. Additionally the present method enables high synthesis space-time yields relative to methods disclosed in WO 2019/204934 through significant reductions in reaction time and elimination of some washing or purification steps.

The use of a zinc oxide, as a zinc reagent, is also demonstrated and departs from the teachings of WO 2019/204934. The present methods demonstrate that a dissolution of ZnO driven by the formation of a less soluble Zn₂₊ containing MOF is enabling a relatively fast formation of the product through dissolution and re-precipitation with little remaining unreacted ZnO.

The invention relates to a method for synthesis of a zinc containing MOF or Zn MOF of formula: Zn₂Ht₂Ox, where;
Ht is a first N-heterocyclic compound selected from 1,2,4-triazolate, or a combination of the first N-heterocyclic compound (1,2,4-triazolate) and a second N-heterocyclic compound, where the first N-heterocyclic compound is different from the second N-heterocyclic compound;
Ox is an oxalate a dianion form of the diacid oxalic acid, and
Zn is a zinc cation.

In an embodiment, the invention provides a method for making a Zn MOF of formula: Zn₂Ht₂Ox, where Zn is a zinc cation; Ht is a first N-heterocyclic compound, particularly a first cycloazocarbyl compound, or more particularly 1,2,4-triazolate; or a combination of the first N-heterocyclic compound, particularly the first cycloazocarbyl compound, or more particularly 1,2,4-triazolate and at least a second N-heterocyclic compound, particularly a second cycloazocarbyl compound where the first N-heterocyclic compound and first cycloazocarbyl compound is different from the second N-heterocyclic compound and second cycloazocarbyl compound, and Ox is oxalate or a combination of oxalate and one or more chelating ligand other than oxalate, which comprises: contacting the 1,2,4 triazole, an oxalate salt, and optionally an zinc salt or a zinc oxide in a liquid suspension where the liquid suspension is at temperature equal to or less than about 100° C. with a solvent comprising a majority or an entirety of water.

In embodiments, the invention can further relate to a Zn MOF containing oxalate and 1,2,4-triazolate of formula: Zn₂Ht₂CL, where Zn is a zinc cation; Ht is a combination of a first N-heterocyclic compound, particularly a first cycloazocarbyl compound, or more particularly 1,2,4-triazolate and at least a second N-heterocyclic compound, particularly a second cycloazocarbyl compound, where the first N-heterocyclic compound is different from the second N-heterocyclic compound; and CL is a combination of oxalate and one or more chelating ligands other than oxalate. In particular, embodiments can relate to Zn MOF, wherein the second cycloazocarbyl compound is imidazolate, 1,2,4-triazolate, pyrazolate, or tetrazolate and/or wherein the other chelating ligand is squarate (squaric acid), or rubeanate (rubeanic acid).

The use of zinc oxide as a zinc reagent of zinc is also disclosed. Dissolution of ZnO driven by the formation of a less soluble Zn₂₊ containing MOF enables a relatively fast formation of the product through dissolution and re-precipitation which can result in little remaining unreacted ZnO at the end of the synthesis process.

The general Zn MOF product has a stoichiometry Zn₂Ht₂Ox, where Ht is a cycloazocarbyl and Ox is oxalate or combination of oxalate and optionally another ligand.

The specific product CALF-20 has a stoichiometry Zn₂Tz₂Ox, where Tz is 1,2,4-triazolate and Ox is oxalate. It is currently believed that the reaction to form the Zn MOF and particularly CALF-20, can be performed with at most a 5% stoichiometric excess of any one component.

In an embodiment, the synthesis of a zinc containing MOF or Zn MOF of formula: Zn₂Ht₂Ox, where;
Ht is a first N-heterocyclic compound selected from 1,2,4-triazolate, or a combination of the first N-heterocyclic compound (1,2,4-triazolate) and a second N-heterocyclic compound, wherein the first N-heterocyclic compound is different from the second N-heterocyclic compound;
Ox is an oxalate a dianion form of a diacid oxalic acid or a dicarboxylic acid or a dithio compound; and
Zn is a zinc cation,
   can comprise a method including contacting the first N-heterocyclic compound and optionally the second N-heterocyclic compound, the oxalate or dicarboxylic acid or dithio compound, and optionally a zinc salt or a zinc oxide, in a liquid suspension where the liquid suspension is at a temperature equal to or less than about 100° C. and at a pressure within 0.9 to 1.1 atmospheres, with a solvent comprising water. The synthesis method can result in the formulation of Zn MOF crystals.

The embodiment can further comprise during adding the zinc salt or the zinc oxide as a zinc reagent to a solution or the liquid suspension, during a first step, adding an oxalate salt to the solution or the liquid suspension during a second step, and adding the first N-heterocyclic compound and optionally the second N-heterocyclic compound as a cycloazocarbyl compound, particularly a second cycloazocarbyl compound, to the solution or the liquid suspension during a third step, wherein the third step is subsequent to the second step and the second step is subsequent to the first step.

The embodiment can further comprise mixing the zinc salt or the zinc oxide as a zinc reagent, the first N-heterocyclic compound and optionally the second N-heterocyclic compound as a cycloazocarbyl compound, particularly a second cycloazocarbyl compound, and an oxalate salt to form a mixture, and subsequently adding the solvent to the mixture.

In another embodiment, the synthesis of a zinc containing MOF or Zn MOF of formula: Zn₂Ht₂Ox, where;
Ht is a first N-heterocyclic compound selected from 1,2,4-triazolate, or a combination of the first N-heterocyclic compound (1,2,4-triazolate) and a second N-heterocyclic compound, wherein the first N-heterocyclic compound is different from the second N-heterocyclic compound;
Ox is an oxalate a dianion form of a diacid oxalic acid or a dicarboxylic acid or a dithio compound; and
Zn is a zinc cation,
   can comprise contacting the first N-heterocyclic compound and optionally the second N-heterocyclic compound, the oxalate or dicarboxylic acid or dithio compound in a liquid suspension where the liquid suspension is at a temperature equal to or less than about 100° C. and at a pressure within 0.9 to 1.1 atmospheres, with a solvent consisting exclusively of water.

In embodiments, the first N-heterocyclic compound can be a first cycloazocarbyl compound, the optional second N-heterocyclic compound is an optional second cycloazocarbyl compound, where the first cycloazocarbyl compound and the optional second cycloazocarbyl compound comprise a 5-member ring or a 6-member ring, the first cycloazocarbyl compound and the optional second cycloazocarbyl compound is at least bidentate and wherein the ring contains 2, 3 or 4 nitrogen and the ring is optionally substituted with a non-hydrogen substituent selected from —NH₂, C₁-C₃ alkyl amino, C₁-C₃ dialkyamino, C₁-C₃ alkyl, C₂-C₃ alkenyl, or C₂-C₃ alkynyl.

In other embodiments, the first N-heterocyclic compound can be a first cycloazocarbyl compound, the optional second N-heterocyclic compound can be a second cycloazocarbyl compound, wherein the first cycloazocarbyl compound and the optional second cycloazocarbyl compound can be bidentate.

Further still, in other embodiments, the first N-heterocyclic compound can be a first cycloazocarbyl compound, the optional second N-heterocyclic compound can be a second cycloazocarbyl compound, wherein the first cycloazocarbyl compound and the optional second cycloazocarbyl compound comprise a 5-member ring or a 6-member ring.

In other embodiments, the first N-heterocyclic compound can be a first cycloazocarbyl compound, the optional second N-heterocyclic compound can be a second cycloazocarbyl compound, wherein the first cycloazocarbyl compound and the optional second cycloazocarbyl compound can be unsubstituted.

In embodiments, the first N-heterocyclic compound can be a first cycloazocarbyl compound, the optional second N-heterocyclic compound can be a second cycloazocarbyl compound, wherein the first cycloazocarbyl compound and the optional second cycloazocarbyl compound can be a bidentate and unsubstituted.

In embodiments, the first N-heterocyclic compound can be a first cycloazocarbyl compound, the optional second N-heterocyclic compound can be a second cycloazocarbyl compound, wherein the first cycloazocarbyl compound and the optional second cycloazocarbyl compound can be an unsubstituted 1,2,4-triazolate, unsubstituted 1,2,3-triazolate, unsubstituted tetrazolate, unsubstituted imidazolate, or unsubstituted pyrazolate.

In embodiments, the first N-heterocyclic compound can be a first cycloazocarbyl compound and optional second N-heterocyclic compound can be an optional second cycloazocarbyl compound, wherein the first cycloazocarbyl compound and the optional second cycloazocarbyl compound can be an imidazolate, a triazolate, 1,2,4-triazolate, 1,2,3-triazolate, a pyrazolate or a tetrazolate.

In other embodiments, the first N-heterocyclic compound can be a first cycloazocarbyl compound and the optional second N-heterocyclic compound can be an optional second cycloazocarbyl compound, wherein the first cycloazocarbyl compound and the optional second cycloazocarbyl compound can be a chelating ligand and is 1,2,4-triazolium oxalate.

Still, in other embodiments, the first N-heterocyclic compound can be a first cycloazocarbyl compound, the optional second N-heterocyclic compound can be a second cycloazocarbyl compound, wherein the first cycloazocarbyl compound and the optional second cycloazocarbyl compound can be selected from the group consisting of 1H-1,2,4-triazolate-1-carboxamidine, 3-amino-1,2,4-triazolate, imidazolate, 4-fluoroimidazolate, 2-methyl-imidazolate and 1,2,3,4-tetrazolate.

In embodiments, the first N-heterocyclic compound can be a first cycloazocarbyl compound, the optional second N-heterocyclic compound can be an optional second cycloazocarbyl compound.

In embodiments, the first N-heterocyclic compound can be a first cycloazocarbyl compound, the optional second N-heterocyclic compound can be a second cycloazocarbyl compound, wherein the first cycloazocarbyl compound and the optional second cycloazocarbyl compound can be unsubstituted 1,2,4-triazolate.

In embodiments, a portion of the first N-heterocyclic compound and the optional second N-heterocyclic compound can be substituted as a reactant, for the 1,2,4-triazole to form a Zn MOF having a mixture of cycloazocarbyl ligands having 1,2,4-triazolate.

In embodiments, the second cycloazocarbyl compound can be imidazolate, 1,2,4-triazolate, pyrazolate, or tetrazolate and/or wherein the other chelating ligand is squarate (from squaric acid), or rubeanate (from rubeanic acid). In embodiments, a molar ratio of the 1,2,4-triazole to the second cycloazocarbyl compound added to the reaction ranges from 1:1 (50 mole % of each) to 100:1.

In embodiments, a molar ratio of 1,2,4-triazole to the second cycloazocarbyl compound added to the reaction can be greater than or equal to 5:1.

In embodiments, a molar ratio of 1,2,4-triazole to the second cycloazocarbyl compound added to the reaction can be greater than or equal to 10:1.

It will be appreciated that a plurality of cycloazocarbyl compounds in addition to 1,2,4-triazole can be employed in reactions herein. In such cases, the molar ratio of 1,2,4-triazole to the total mixture of other cycloazocarbyl compounds, for example, the other cycloazocarbyl compounds can have a second cycloazocarbyl compound and a third cycloazocarbyl compound, may be calculated from the ratios above, for example, a 1:1 molar ratio is an equivalent of 50 mole percent of each. The hydrate of oxalic acid can be oxalic acid dihydrate.

In embodiments, the diacid can be squaric acid.

In embodiments, the dithio compound can be rubeanic acid, where the dithio compound can be an alternative chelating agent.

In embodiments, a molar ratio of a first ligand, for example, oxalate to a second ligand added to the reaction ranges from 1:1 (50 mole percent of each) to 100:1.

In embodiments, a molar ratio of a first ligand, for example, oxalate to a second ligand added to the reaction is greater than or equal to 5:1.

In embodiments, a molar ratio of a first ligand, for example, oxalate to a second ligand added to the reaction is greater than or equal to 10:1.

It will be appreciated that two or more chelating ligands in addition to oxalate can be employed in reactions herein. In such cases, the molar ratio of oxalate to the total mixture of other chelating ligands, for example, a second ligand and a third ligand, may be calculated from the ratios above.

In embodiments, the synthesis of a zinc containing MOF or Zn MOF of formula Zn₂Ht₂Ox, where;
Ht is 1,2,4-triazolate;
Ox is an oxalate a dianion form of the diacid oxalic acid; and
Zn a is zinc cation, can comprise contacting the 1,2,4 triazole, an oxalate reagent, and a zinc salt or a zinc oxide, in a liquid suspension where the liquid suspension is at a temperature equal to or less than about 100° C. and at a pressure within a pressure range of 0.9 to 1.1 atmospheres, with a solvent comprising water.

In embodiments, the synthesis of a zinc containing MOF or Zn MOF of formula Zn₂Ht₂Ox, where;
Ht is 1,2,4-triazolate;
Ox is an oxalate a dianion form of the diacid oxalic acid; and
Zn is a zinc cation;
   can comprise contacting the 1,2,4 triazole, an oxalate reagent, and a zinc salt or a zinc oxide in a liquid suspension where the liquid suspension is at a temperature equal to or less than about 100° C. and at a pressure within a pressure range of 0.9 to 1.1 atmospheres, with a solvent consisting exclusively of water.

In embodiments, a reaction to form Zn MOF can be performed with equal to or less than a 5% stoichiometric excess of any one component, for example, the Ht component, the Ox component, and/or the Zn component.

In embodiments, a reaction to form Zn MOF can be performed with a stoichiometric excess in a range of 10% to 100% of triazole.

In embodiments, the zinc salt can be a zinc reagent consisting of zinc carbonate, zinc acetate dihydrate, zinc chloride, or zinc nitrate.

In embodiments, the zinc oxide can be a zinc reagent.

In embodiments, the oxalate reagent is lithium oxalate, sodium oxalate, potassium oxalate or oxalic acid or a combination of any of those.

In embodiments, an aqueous alcohol containing one lower alcohol can be added. The aqueous alcohol can be used as a solvent and/or dispersant.

In embodiments, the aqueous alcohol can be aqueous ethanol or aqueous methanol.

In embodiments, an aqueous alcohol can contain 10% or more by volume of one or more alcohols, particularly 10% or more by volume of one or more lower alcohols.

In embodiments, an aqueous alcohol can contain 25% or more by volume of one or more of one or more alcohols, particularly 25% or more by volume of one or more lower alcohols.

In embodiments, an aqueous alcohol can contain 50% or more by volume of one or more alcohols, particularly 50% or more by volume of one or more lower alcohols.

In embodiments, an aqueous alcohol can contain 40-60% by volume of one or more alcohols, particularly 40-60% by volume of one or more lower alcohols.

Separate liquid solutions or liquid suspensions, can contain, respectively, a desired stoichiometric amount of the zinc salt or zinc oxide to the oxalic acid to the cycloazocarbyl compound, which can be a molar ratio of 2:1:2 of zinc cation to oxalic acid to a total amount of cycloazocarbyl compounds. For example, the first cycloazocarbyl compound, or the first and second cycloazocarbyl compound, can be used for the reaction.

Preferably, in embodiments, the three components, zinc cation, oxalic acid and one or more cycloazocarbyl compound, can be combined with equal to or less than a 5% stoichiometric (molar) excess or a deficiency of any of the three components in order to maximize product yield and or minimize formation of hard to wash out co-precipitates.

In embodiments, an order of addition of liquid solutions or liquid suspension can be as follows: in a first step adding a first cycloazocarbyl, optionally a second cycloazocarbyl and the oxalate followed by a second step of adding a zinc compound; in a first step adding a zinc compound with a first cycloazocarbyl and optionally a second cycloazocarbyl, followed by a second step of adding the oxalate last; in a first step adding a zinc compound with the oxalate followed by a subsequent step of adding a first cycloazocarbyl and optionally a second cycloazocarbyl last; or in a first step mixing all of the solid components, for example, a first cycloazocarbyl, optionally a second cycloazocarbyl, the oxalate, and a zinc compound followed by a second step of adding a solvent last. The first N-heterocyclic compound can be the first cycloazocarbyl, the optional second N-heterocyclic compound can be the second cycloazocarbyl compound. The first N-heterocyclic compound is different from the second N-heterocyclic compound.

If the starting materials employed contain impurities, unintended deviations from the desired stoichiometric can occur, as will be appreciated by one of ordinary skill in the art. Starting materials of purity needed to achieve the desired stoichiometry are commercially available or can be prepared by methods well known in the art.

The resulting mixture can be then stirred until formation of the Zn MOF is complete.

The reaction can be conducted at an ambient room temperature, for example, about 15° C. to about 30° C., or optionally at a temperature up to about 100° C. Reagent suspensions can be, optionally, heated to above room temperature prior to mixing.

In embodiments, reagents, suspensions, and/or solutions are heated to and/or controlled to a temperature above ambient temperature, for example, about 15° C., preferably a temperature between about ambient temperature and about 60° C., more preferably a temperature between about ambient temperature and about 30° C., prior to mixing.

In other embodiments, reagents, suspensions, and/or solutions are heated to and/or controlled to a temperature above ambient temperature, for example, about 15° C., preferably a temperature between about ambient temperature and about 90° C., more preferably a temperature between about ambient temperature and about 60° C., prior to mixing.

Further still, in other embodiments, reagents, suspensions, and/or solutions are heated to and/or controlled to a temperature above ambient temperature for example, about 15° C., preferably a temperature between about ambient temperature and about 100° C., more preferably a temperature between about ambient temperature and about 90° C., prior to mixing.

In embodiments, after addition of a last reagent or reagent suspension, the reaction mixture can be heated to reflux under atmospheric pressure employing an appropriate condenser or related known equipment to avoid loss of solvent, the temperature of which reflux depends on the solvent or solvent mixture employed. Heating the reaction mixture is found to increase the rate of formation of the Zn MOF.

The Zn MOF of the forgoing methods can be collected from the suspension by any suitable filtration method and washed with an appropriate solvent, water, a lower alcohol or a miscible mixture thereof. The washing solvent(s) may be the same or different from those employed in the reaction. The washing solvent(s) are preferably the same as the solvent or solvents used in the reaction.

Degree of completion of reaction and purity of the product can be assessed by PXRD (powder X-ray diffraction) or by testing of powder surface area using Brunauer-Emmett-Teller (BET) surface area analysis or by measuring specific gas adsorption properties.

In embodiments, the Zn MOF prepared by the methods herein has a powder X-ray diffraction pattern having the highest intensity diffraction peak in a range of 10°<20<15° with Cu K alpha radiation.

In embodiments, the Zn MOF prepared by the methods herein is in the form of a powder and has a Langmuir surface area of equal to or greater than 450m² /g determined according to the Langmuir sorption model applied to a nitrogen sorption isotherm at 77° K, as is known in the art.

The Zn MOF prepared by the methods herein has pores. In an embodiment, a Zn MOF has pores within a single domain crystal, the pores in the single domain crystal having a pore size in a range of 0.3 to 2 nm. Preferred Zn MOFs prepared by the methods herein can have pore size ranging in nm from 0.4 to 1.9, from 0.5 to 1.8, from 0.6 to 1.7, or from 0.7 to 1. In specific embodiments, Zn MOFs prepared by the methods herein can have pore size in nm or about 0.3, about 0.4, about 0.5, about 0.6, about 0.7, about 0.8, about 0.9, about 1.0, about 1.1, about 1.2, about 1.3, about 1.4, about 1.5, about 1.6, about 1.7, about 1.8, about 1.9 or about 2.0.

The Zn MOFs prepared as described herein can be employed in a method for sorptive separation of a first component, for example, and acid gas component or carbon dioxide from a gas mixture containing the first component, acid gas or carbon dioxide, the separation method comprising the step of (a) contacting the gas mixture with at least one sorbent comprising the Zn MOF, (b) sorbing the first component in and/or on the Zn MOF and recovering a first product gas stream depleted in the first component relative to the gas mixture, and (c) desorbing the selectively adsorbed or first component from the Zn MOF through at least one of a pressure swing, a temperature swing, a partial pressure swing, and a moisture swing; and recovering a second product gas stream enriched in the first component relative to the gas mixture.

The Zn MOF can formed into sorbent sheets of thickness between 100 and 1000 micrometers that are further assembled into contactors, parallel passage contactors, or contactor beds for the purpose of separation of gas components in particular carbon dioxide separation and removal from industrial flue gas.

### EXAMPLES

The following reactions are conducted at ambient room temperature and ambient room pressure without heating the components unless otherwise indicated.

Thermo-gravimetric analysis is a simple tool to assess the degree of adsorption of CO₂ on a selected powder sample at a set temperature and under a set concentration of CO₂. In the examples below, CO₂ adoption capacity at 50° C. under 15% CO₂ in nitrogen is used to verify the quality of the product formed through the different exemplary synthesis process disclosed.

### Example 1

Adding Zn first in an aqueous solvent with MOF crystal formation under atmospheric reflux condition (100° C.) the Zn MOF was prepared without an adduct step. A five litre 3-neck-round-bottom flask equipped with over-head stirrer, thermocouple, condenser and heating mantle, was charged with 336 g (3 mol) zinc carbonate basic, added with 600 ml DIH₂O under 50 rpm slow agitation. Oxalic acid di-hydrate powder 190.6 g (1.507 mol) was added in 8 minutes under 100 rpm agitation, during which CO₂ was released. After dosing, the slurry was agitated for 30 min under 150 rpm to allow CO₂ release. 1,2,4-triazole 208.9 g (3 mol) dissolved in 400 ml DIH₂O was added into the flask in 5 min, followed by further agitation for about 30 min, during which CO₂ was further released. The aqueous suspension was heated to reflux temperature while agitated at 250 rpm and kept at approximatively 100° C. for one hour. The suspension was then retrieved and its temperature quenched by adding cold distillated water into the slurry product prior to transfer to a Buchner funnel for filtration. The cake formed was then rinsed with distilled water until filtrate conductivity reach below 100 microsiemens/cm. After drying the powder at 110° C. under air for about 20 hr, 529 g powder was obtained (99% to theoretical weight). The powder CO₂ capacity at 50° C. with 15% CO₂ in nitrogen was measured at 46.2 cc/g.

### Example 2

A 500 ml 3-neck-round-bottom flask equipped with an over-head stirrer, a thermocouple, a condenser and a heating mantle was used. The flask was charged with 33.6 g (0.3 mol) zinc carbonate basic, oxalic acid di-hydrate 19.06 g (0.15 mol) and 1,2,4-triazole 20.89 g (0.3 mol). Under agitation, 110 ml distilled water was added in 30 min. After addition of water, the slurry was agitated for another 20 min with 250 rpm agitation to allow for completion of the reaction and CO₂ release, followed by heating to reflux (about 100° C.) under 350 rpm agitation maintained for 1 hr. Distilled water was added into the slurry product and filtrated with a Buchner funnel under suction, followed by flushing the cake with distilled water until filtrate conductivity was lower than 100 microsiemens/cm. After drying the powder at 110° C. about 20 hr, 53.3 g powder was obtained (almost 100% to theoretical weight). The dry powder CO₂ capacity at 50° C., 15% CO₂ in Nitrogen was 34.9 cc/g.

### Example 3

In a 500 ml jacketed beaker, zinc acetate dihydrate powder (44 g, 0.2 mol) was dissolved in 120 ml distilled water already warmed up at 50° C. After complete dissolution of the salt, oxalic acid dihydrate powder (12.6 g, 0.1 mol) was slowly added into the solution while it mixing the solution. After 30 minutes, the 1,2,4-triazole (21 g or 0.3 mol) was added slowly and the solution mixed overnight at 50° C. The solid content of the slurry was calculated as 39.3% weight. After reaction completion, the precipitated product was filtrated with a butcher funnel under suction, followed by washing the cake with distilled water until filtrate conductivity was lower than 100 microsiemens/cm. After drying the powder at 110° C. about 20 hr, 30 g powder was obtained. The dried powder CO₂ capacity at 50° C., 15% CO₂ in Nitrogen was 42.4 cc/g.

### Example 4

In a 500 ml jacketed beaker, zinc acetate dihyrdate powder (44 g, 0.2 mol) was dissolved in 80 ml DIH₂O already warmed up at 50° C. After complete dissolution of the zinc salt, oxalic acid dihydrate powder (12.6 g, 0.1 mol) was slowly added into the solution while being mixed. After 30 min, the 1,2,4-triazole (21 g, 0.3 mol) was added slowly and the solution mixed overnight at 50° C. The solid content of the slurry was increased to 49.2% weight compared to example 3. After drying the powder at 110° C. about 20 hr, 30 g powder was obtained. The dried powder CO₂ capacity at 50° C., 15% CO₂ in nitrogen was 42.6 cc/g.

### Example 5

In a 500 ml jacketed beaker, zinc acetate dihydrate powder (44 g, 0.2 mol) was dissolved in 120 ml DIH₂O water already warmed up at 50° C. After complete dissolution of the zinc salt, oxalic acid dihydrate powder (12.6 g, 0.1 mol) was slowly added into the solution while mixed. After 30 min, the 1,2,4-triazole (28 g, 0.4 mol) was added slowly and the solution mixed overnight at 50° C. The solid content of the slurry was calculated as 41.0% weight. After reaction completion, the precipitated product was filtrated with a Buchner funnel under suction, followed by flushing the cake with distilled water until filtrate conductivity was lower than 100 microsiemens/cm. After drying the powder at 110° C. about 20 hr, 28 g powder was obtained. The dried powder CO₂ capacity at 50° C., 15% CO₂ in nitrogen was 41.0 cc/g.

### Example 6

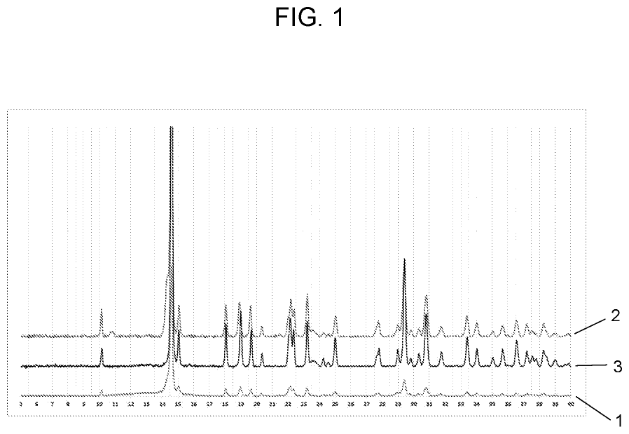

FIG. 1 shows and compares X-ray diffraction patterns for materials prepared in Example 3, Example 4 and following the method described in WO2019/204934. In FIG. 1, the x-axis is 2-theta-degree while the y-axis is intensity. X-ray diffraction line 1 is for the material prepared by the process disclosed in WO 2019/204934. X-ray diffraction line 2 is for the material prepared in Example 3, X-ray diffraction line 3 is for the material prepared in Example 4. The diffraction peaks in X-ray diffraction lines 1, 2, and 3 are substantially the same which indicates the materials prepared by these methods have substantially the same structure.

### Example 7

A one litre beaker with high shear mixer was loaded with 150 ml MeOH (ACS grade) and 150 ml RO H₂O (reverse osmosis water). Under 350 rpm agitation, oxalic acid dihydrate 77.2 g (98%, 0.6 mol) and 1,2,4-triazole 84.4 g (99%, 1.21 mol) are added in sequence. The mix was agitated for 1.5 hr for adduct formation, during which viscosity increases and agitation speed was adjusted to 1245 rpm to provide sufficient agitation. Zinc carbonate basic 135.3 g (58% Zn, 1.2 mol) was added in portions during 5 hr period with agitation speed adjusted from 1245 rpm to 3277 rpm. 80 ml extra solvent (MeOH/H₂O=1/in vol) was added to dilute the slurry, which was thought too dry. Agitation overnight (16 hr), and 82 ml MeOH/H₂O (1/1 vol) was added to make the slurry wet and agitate at 4397 rpm until 18 hr. The sample was taken and dried in an oven at 90° C., TGA test CO₂ capacity at 15% CO₂/50° C. After 21 hr of agitation, the reaction was stopped and after post-treatment and drying, capacity was 44.1cc/g for CO₂ under 15% CO₂ in nitrogen at 50° C.

### Example 8

A one litre beaker with anchor shape blade and non-display overhead stirrer was loaded with 100 ml MeOH (ACS grade) and 100 ml RO H₂O. Under non-splash agitation, zinc carbonate basic 112.75 g (58% Zn, 1.0 mol) was added. 1,2,4-triazole 69.78 g (99%, 1.0 mol) was added in 1 portion. The mix was agitated for 20 min, during which, solid attached to the beaker wall was pushed into slurry with spatula. Oxalic acid dihydrate 64.33 g (98%, 0.5 mol) was added in portions during 1.25 hr, during which 50 ml MeOH/H₂O (1/1 vol) was added. The mix was agitated until the 3^{rd} day, in total 40.5 hr and 100 ml mix solvent was added since the product is dry. As-synthesized powder capacity is 39.8 cc/g for CO₂ under 15% CO₂ in nitrogen at 50° C. After washing with H₂O and drying, capacity was 44.5cc/g for CO₂ under 15% CO₂ in nitrogen at 50° C.

### Example 9

A 500 mL 3-neck-round-bottom flask equipped with over-head stirrer, thermocouple, condenser and heating mantle, was charged with oxalic acid di-hydrate 19.05 g (0.15 mol) and distilled water (DIH₂O) 50 ml. Zinc oxide 24.54 g (0.3 mol) was added during 22 min under 250 rpm agitation, and DIH₂O 20 ml was used to flush the powder on the mouth of the flask into the flask. After an additional 40 min of agitation, a solution of 1,2,4-triazole 20.89 g (0.3 mol) dissolved in 30 ml DIH₂O was fed into the flask, followed by 20 ml DIH₂O rinsing of the beaker and flask mouth. After 30 min agitation at 350 rpm, the reaction slurry was heated over 90° C. and maintained for 3.75 hr. DIH₂O was added into the slurry and filtrated with Buchner funnel under suction, followed by flushing the cake with DIH₂O until filtrate conductivity lower than 100 microsiemens/cm. After drying the powder at 110° C. about 20 h, 52.6 g powder was obtained. CO₂ capacity at 50° C., 15% CO₂ in nitrogen was 40.4 cc/g.

TABLE 1
Comparison of synthesis parameters and powder test-
results of Example 7 and Example 8. CALF-20 was successfully
prepared in Example 7 and Example 8.

| | Example 7 | Example 8 |
|---|---|---|
| Reaction scale, powder weight (g) | 200 | 200 |
| Solvent used | MeOH/H₂O | MeOH/H₂O |
| | (150/150 ml) | (150/150 ml) |
| Molar Ratio Zn/Ox/Tz | 1/0.5/1 | 1/0.5/1 |
| Last component addition time (hr) | 5 | 1.25 |
| Temperature (° C.) | 10-30 | 10-30 |
| Agitation | High Shear | Normal |
| Agitation time | 21 hours | 48 hours |
| CO₂ capacity under 15% CO₂ in | 44.1 | 44.5 |
| Nitrogen at 50° C., (CC/g) | | |

What is claimed is:

1. A method for preparing a Zn MOF of composition of formula Zn₂Ht₂Ox, where Ht is a first N-heterocyclic compound and is either a 1,2,4-triazolate or a combination of a 1,2,4-triazolate and at least a second N-heterocyclic compound, wherein said second N-heterocyclic compound is different from said first N-heterocyclic compound, Ox is an oxalate, a dianion form of a diacid oxalic acid, a dicarboxylic acid or a dithio compound, and Zn is a zinc cation, the method comprising:
contacting said first N-heterocyclic compound, said Ox, and a solvent comprising water in a liquid suspension which is at a temperature equal to or less than 100° C. and at a pressure within a range of 0.9 to 1.1 atmospheres, and
forming crystals of said Zn MOF.

2. The method of claim 1, wherein contacting said first N-heterocyclic compound, said Ox and a solvent comprising water further comprises contacting said second N-heterocyclic compound with said first N-heterocyclic compound, said Ox and said solvent.

3. The method of claim 1, further comprising:
adding a zinc salt or a zinc oxide as a zinc reagent to a solution or a liquid suspension during a first step,
adding an oxalate salt to said solution or said liquid suspension during a second step, and
adding said first N-heterocyclic compound as a first cycloazocarbyl compound to said solution or said liquid suspension during a third step.

4. The method of claim 1, wherein said solvent further comprises exclusively of water.

5. The method of claim 2, wherein said solvent further comprises exclusively of water.

6. The method of claim 3, wherein said zinc reagent further comprises one of zinc oxide, zinc acetate, zinc salt, zinc carbonate, zinc acetate dihydrate, zinc chloride, or zinc nitrate.

7. The method of claim 1, wherein said temperature of said liquid suspension is within a range of 15° C. to 100° C.

8. A method for preparing a zinc containing MOF or Zn MOF of formula Zn₂Ht₂Ox, where Ht is a 1,2,4-triazolate, Ox is an oxalate, a dianion form of the diacid oxalic acid, and Zn is a zinc cation, the method comprising:
contacting said 1,2,4 triazole, an oxalate salt, and a zinc salt or a zinc oxide, and a solvent comprising water, in a liquid suspension which is at a temperature equal to or less than 100° C. and at a pressure within a range of 0.9 to 1.1 atmospheres.

9. The method of claim 8, wherein said solvent further comprises exclusively water.

10. The method of claim 8, wherein said method is performed with equal to or less than a 5% stoichiometric excess of any one component.

11. The method of claim 8, wherein said method is performed with a stoichiometric excess in a range of 10% to 100% of triazole.

12. The method of claim 8, further comprising adding a zinc reagent in a first step.

13. The method of claim 12, wherein said zinc reagent further comprises one of zinc carbonate, zinc acetate dihydrate, zinc chloride, zinc nitrate, or zinc oxide.

14. The method of claim 8, further comprising adding said oxalate is one of lithium oxalate, sodium oxalate, potassium oxalate or oxalic acid or a combination thereof.

15. The method of claim 1, further comprising adding an aqueous alcohol.

16. The method of claim 15, wherein said aqueous alcohol contains 10% or more by volume of one or more alcohols, particularly 10% or more by volume of one or more lower alcohols.

17. The method of claim 8, further comprising conducting a reaction at a temperature within a temperature range of 15° C. to 30° C.

18. The method of claim 1, further comprising controlling a temperature of one or more reagent and/or said liquid suspension to a desired temperature, prior to mixing.

19. The method of claim 18, further comprising controlling said one or more reagent and/or said liquid suspension to a temperature between 15° C. to 100° C., prior to mixing.

20. The method of 1, further comprising after addition of a last reagent or a suspension for said last reagent, a reaction mixture can be heated to reflux under atmospheric pressure.
